(19) United States
(12) Patent Application Publication
(10) Pub. No.: US 2025/0068690 A1
(43) Pub. Date: Feb. 27, 2025

(54) CALCULATING DEVICE, CALCULATION PROGRAM, AND CALCULATION METHOD

(71) Applicant: KABUSHIKI KAISHA TOSHIBA, Tokyo (JP)

(72) Inventor: Hayato GOTO, Kawasaki Kanagawa (JP)

(73) Assignee: KABUSHIKI KAISHA TOSHIBA, Tokyo (JP)

(21) Appl. No.: 18/663,632

(22) Filed: May 14, 2024

(30) Foreign Application Priority Data
Aug. 24, 2023 (JP) 2023-136476

(51) Int. Cl. G06F 17/11

(52) U.S. Cl. CPC G06F 17/11

(57) ABSTRACT

According to one embodiment, a calculating device includes an acquisition part configured to acquire a problem parameter set, and a processor. The processor is configured to repeatedly perform a first variable update of updating a first variable set, and a second variable update of updating a second variable set. In the second variable update, the processor updates the second variable set by using a function including a first term and a second term. The first term includes the first variable set and a bifurcation parameter set. The second term includes the first variable set and the problem parameter set acquired by the acquisition part. In the first variable update, the processor updates the first variable set by using the second variable set updated in the second variable update. The bifurcation parameter set includes a first bifurcation parameter and a second bifurcation parameter.

### CROSS-REFERENCE TO RELATED APPLICATIONS

This application is based upon and claims the benefit of priority from Japanese Patent Application No. 2023-136476, filed on Aug. 24, 2023; the entire contents of which are incorporated herein by reference.

### FIELD

Embodiments described herein relate generally to a calculating device, a calculation program, and a calculation method.

### BACKGROUND

An optimization problem or the like is solved by a calculating device. It is desirable to increase the calculation accuracy of the calculating device.

### BRIEF DESCRIPTION OF THE DRAWINGS

FIG. 1 is a flowchart illustrating an operation of a calculating device according to an embodiment;

FIG. 2 is a schematic view illustrating the calculating device according to the embodiment;

FIG. 3 is a flowchart illustrating an operation of the calculating device according to the embodiment;

FIG. 4 is a flowchart illustrating an operation of the calculating device according to the embodiment;

FIG. 5 is a flowchart illustrating an operation of the calculating device according to the embodiment; and

FIG. 6 is a flowchart illustrating an operation of the calculating device according to the embodiment.

### DETAILED DESCRIPTION

According to one embodiment, a calculating device includes an acquisition part configured to acquire a problem parameter set, and a processor. The processor is configured to repeatedly perform a first variable update of updating a first variable set, and a second variable update of updating a second variable set. In the second variable update, the processor updates the second variable set by using a function including a first term and a second term. The first term includes the first variable set and a bifurcation parameter set. The second term includes the first variable set and the problem parameter set acquired by the acquisition part. In the first variable update, the processor updates the first variable set by using the second variable set updated in the second variable update. The bifurcation parameter set includes a first bifurcation parameter and a second bifurcation parameter. The first bifurcation parameter corresponds to one of a plurality of first variables included in the first variable set. The second bifurcation parameter corresponds to another one of the plurality of first variables. A first initial value of the first bifurcation parameter is different from a second initial value of the second bifurcation parameter.

Various embodiments are described below with reference to the accompanying drawings.

In the specification and drawings, components similar to those described previously in an antecedent drawing are marked with like reference numerals, and a detailed description is omitted as appropriate.

### First Embodiment

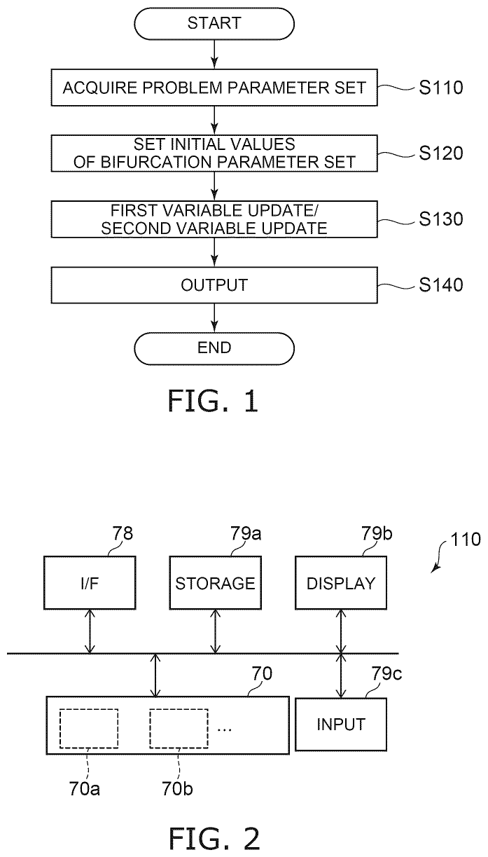

FIG. 1 is a flowchart illustrating an operation of a calculating device according to an embodiment.

FIG. 2 is a schematic view illustrating the calculating device according to the embodiment.

As shown in FIG. 2, the calculating device 110 according to the embodiment includes a processor 70 and an acquisition part 78. As described below, the processor 70 is configured to repeatedly perform first variable update processing and second variable update processing.

The processor 70 may include, for example, a CPU (Central Processing Unit), etc. The processor 70 includes, for example, an electronic circuit, etc. The calculating device 110 may be a calculation system.

In the example, the calculating device 110 includes the acquisition part 78. For example, the acquisition part 78 is configured to acquire various data. The acquisition part 78 includes, for example, an I/O port, etc. The acquisition part 78 is an interface. The acquisition part 78 may include the function of an output part. The acquisition part 78 may include, for example, a communication function.

In the example, the calculating device 110 includes storage 79a. The storage 79a is configured to store various data. The storage 79a may be, for example, memory. The storage 79a may include at least one of ROM (Read Only Memory) or RAM (Random Access Memory).

The calculating device 110 may include a display 79b, an input part 79c, etc. The display 79b may include various display devices. The input part 79c includes, for example, a device (e.g., a keyboard, a mouse, a touch input panel, a voice recognition input device, etc.) that includes an operation function.

Multiple components that are included in the calculating device 110 can communicate with one another by at least one of wired or wireless methods. The locations at which the multiple components included in the calculating device 110 are located may be different from one another. For example, a general-purpose computer may be used as the calculating device 110. For example, multiple computers that are connected to one another may be used as the calculating device 110. A special-purpose circuit may be used as at least a part of the calculating device 110 (e.g., the processor 70, etc.). For example, multiple circuits that are connected to one another may be used as the calculating device 110.

As shown in FIG. 2, the processor 70 may include multiple processing parts (e.g., a first processing part 70a, a second processing part 70b, etc.). The multiple processing parts may operate in parallel. For example, parallel processing (parallel computation) may be performed.

Examples of operations performed by the calculating device 110 according to the embodiment will now be described. FIG. 1 illustrates an operation performed by the calculating device 110.

As shown in FIG. 1, a problem parameter set is acquired (step S110). Step S110 is performed by the acquisition part 78. Thus, the acquisition part 78 is configured to acquire the problem parameter set. In one example, the problem parameter set may be, for example, a J-matrix.

As shown in FIG. 1, an initial value of a bifurcation parameter set is set (step S120). For example, the setting of the initial value may be performed by the processor 70. As described below, for example, the initial value may be set according to the problem parameter set acquired in step S110. Or, as described below, the acquisition part 78 may acquire information related to the initial values of at least a part of the bifurcation parameter set.

As shown in FIG. 1, the processor 70 is configured to repeatedly perform a first variable update of updating a first variable set, and a second variable update of updating a second variable set (step S130). For example, the first variable update and the second variable update are alternately performed. The order of performing the first and second variable updates may be arbitrary.

The first variable update and the second variable update end when a determined state is obtained; and the processing result is output (step S140). In one example, step S130 ends when the number of iterations of the first and second variable updates reaches a determined value. In step S140, the processor 70 outputs the values obtained by repeating the first and second variable updates. For example, the output may be performed via an interface (e.g., the acquisition part 78). The values obtained by repeating the first and second variable updates may be, for example, a function of the first variable, etc.

The first variable set {x} includes multiple first variables. The multiple first variables include, for example, a first variable xᵢ. “i” is an integer not less than 1 and not more than N. N is an integer not less than 2. The second variable set {y} includes multiple second variables. The multiple second variables include, for example, a second variable yᵢ. The problem parameter set {J} includes multiple problem parameter subsets Jᵢ. The problem parameter subset {Jᵢ} includes, for example, J_{i,j}. Here, “j” is an integer not less than 1 and not more than M. “M” is an integer not less than 2.

In one example, the processing of the following first formula is performed in the second variable update.

$${y}_{i} ← {y}_{i} + d t ( - {p}_{i} {x}_{i} + cf ( {J}_{i} , \{ x \} ) ) \qquad ( 1 )$$

In the second variable update as shown in the first formula, the processor 70 updates the second variable set {y} by using a function including a first term and a second term. The first term of the first formula is “−pᵢxᵢ”. The second term of the first formula is cf((Jᵢ, {x})). The function f((Jᵢ, {x})) included in the second term may be any function of the problem parameter subset Jᵢ and the first variable set {x}.

In one example, the function f of the first formula is represented by the following second formula.

$$f ( {J}_{i} , \{ x \} ) = {\sum }_{j = 1}^{N} {J}_{i , j} {x}_{j} \qquad ( 2 )$$

The first term of the first formula includes the first variable set {x} and the bifurcation parameter set {p}. The bifurcation parameter set {p} includes multiple bifurcation parameters pᵢ. The first term includes, for example, the product of the first variable set {x} and the bifurcation parameter set {p}.

For example, the bifurcation parameter set {p} is the entries p_{i,j} of a positive definite symmetric matrix P. The positive definite symmetric matrix P is a symmetric matrix in which all of the eigenvalues are positive real numbers. The first term of the first formula may be given by the following third formula.

$$- {\sum }_{j} {p}_{i , j} {x}_{j} \qquad ( 3 )$$

The first term of the first formula corresponds to when the positive definite symmetric matrix P is a diagonal matrix.

The second term of the first formula includes the first variable set {x} and the problem parameter {J} acquired by the acquisition part 78. The second term includes, for example, the product-sum of the problem parameter set {J} and the first variable set {x}. In the first formula, “c” is a parameter. Any function of “xⱼ” may be used as the “xⱼ” in the second term of the first formula. The function “xⱼ” may be, for example, the sign of “x;”, i.e., sign(xⱼ), etc.

The processing of the following fourth formula is performed in the first variable update.

$${x}_{i} ← {x}_{i} + dt \frac{{y}_{i}}{{m}_{i}} \qquad ( 4 )$$

In the first variable update as shown in the fourth formula, the processor 70 updates the first variable set {x} by using the second variable set {y} updated in the second variable update. In the fourth formula, {m} is a parameter set (e.g., a weight parameter set). In the fourth formula of the example, the first variable set {x} is updated using the product of the second variable set {y} and the reciprocal of the weight parameter set {m}.

For example, the weight parameter set {m} is the entries b_{i,j} of a positive definite symmetric matrix B. The second term of the fourth formula may be given by the following fifth formula.

$$d t {\sum }_{j} {b}_{i , j} {y}_{j} \qquad ( 5 )$$

The second term of the fourth formula corresponds to when the positive definite symmetric matrix B is a diagonal matrix.

According to the embodiment, at least two initial values of the multiple bifurcation parameters included in the bifurcation parameter set {p} are different from one another. A more accurate solution is obtained thereby. At least two values of the multiple weight parameters included in the weight parameter set {m} may be different from one another. A more accurate solution is easily obtained thereby.

The multiple bifurcation parameters pᵢ included in the bifurcation parameter set {p} include a first bifurcation parameter p₁ and a second bifurcation parameter p₂. The first bifurcation parameter p₁ corresponds to one (e.g., x₁) of the multiple first variables x; included in the first variable set {x}. The second bifurcation parameter p₂ corresponds to another one (e.g., x₂) of the multiple first variables xᵢ. The first initial value p₁₍₀₎ of the first bifurcation parameter p₂ is different from the second initial value p₂₍₀₎ of the second bifurcation parameter p₂. A more accurate solution is obtained by such a configuration. For example, the first initial value p₁₍₀₎ corresponds to the first bifurcation parameter p₁ at the initial update of the iterations of the second variable update. For example, the second initial value p₂₍₀₎ corresponds to the second bifurcation parameter p₂ at the initial update of the iterations of the second variable update.

For example, the Hamiltonian H of the system of the problem is represented by the following sixth formula.

$$H = \frac{1}{2} {\sum }_{i = 1}^{N} \frac{{y}_{i}^{2}}{{m}_{i}} + \frac{1}{2} {\sum }_{i = 1}^{N} {p}_{i} {x}_{i}^{2} + cg ( \{ J \} , \{ x \} ) \qquad ( 6 )$$

In the sixth formula, the function g of {J} and {x} corresponds to the objective function of the problem. In one example, the function g may be represented by the following seventh formula.

$$g ( \{ J \} , \{ x \} ) = \frac{1}{2} {\sum }_{i = 1}^{N} {\sum }_{j = 1}^{N} {J}_{i , j} {x}_{i} {x}_{j} \qquad ( 7 )$$

The following eighth and ninth formulas are derived from the sixth formula.

$${\dot{x}}_{i} = \frac{\partial H}{\partial {y}_{i}} = \frac{{y}_{i}}{{m}_{i}} \qquad ( 8 )$$

$${\dot{y}}_{i} = - \frac{\partial H}{\partial {x}_{i}} = - {p}_{i} {x}_{i} + cf ( {J}_{i} , \{ x \} ) \qquad ( 9 )$$

The function f of the ninth formula is represented by the following tenth formula.

$$f ( {J}_{i} , \{ x \} ) = - \frac{\partial g}{\partial {x}_{i}} \qquad ( 10 )$$

The first formula corresponds to the ninth formula. The fourth formula corresponds to the eighth formula.

For example, the Hamiltonian H of the system of the problem may be represented by the following eleventh formula.

$$H = \frac{1}{2} {\sum }_{j} {b}_{i , j} {y}_{i} {y}_{j} + \frac{1}{2} {\sum }_{j} {p}_{i , j} {x}_{i} {x}_{j} + cg ( \{ J \} , \{ x \} ) \qquad ( 11 )$$

When the eleventh formula is applied, the eighth and ninth formulas become the following twelfth and thirteenth formulas.

$${\dot{x}}_{i} = \frac{\partial H}{\partial {y}_{i}} = {\sum }_{j} {b}_{i , j} {y}_{j} \qquad ( 12 )$$

$${\dot{y}}_{i} = - \frac{\partial H}{\partial {x}_{i}} = - {\sum }_{j} {p}_{i , j} {x}_{j} + cf ( {J}_{i} , \{ x \} ) \qquad ( 13 )$$

The sixth, eighth, and ninth formulas correspond to one example related to the eleventh, twelfth, and thirteenth formulas.

In the ninth formula (or the first formula), initial values pio of the multiple bifurcation parameters p; are given by, for example, the fourteenth formula.

$${p}_{i 0} = {p}_{0} {\sum }_{j = 1}^{N} \vert {J}_{i , j} \vert \qquad ( 14 )$$

In the fourteenth formula, “p₀” is a coefficient.

Thus, the initial values of the bifurcation parameter set {p} may be determined based on the problem parameter set {J}. For example, the processor 70 is configured to determine the initial values of the multiple bifurcation parameters p; included in the bifurcation parameter set {p} based on the problem parameter set {J}.

For example, the problem parameter set {J} includes a first problem parameter subset J₁ and a second problem parameter subset J₂. For example, the first initial value p₁₍₀₎ of the first bifurcation parameter p₁ is determined based on a first sum of the absolute values of the multiple elements included in the first problem parameter subset J₁. For example, the second initial value p₂₍₀₎ of the second bifurcation parameter p₂ is determined based on a second sum of the absolute values of the multiple elements included in the second problem parameter subset J₂. For example, when the first sum is greater than the second sum, the first initial value p₁₍₀₎ is greater than the second initial value p₂₍₀₎; however, for example, when the first sum is less than the second sum, the first initial value p₁₍₀₎ is less than the second initial value p₂₍₀₎.

Thus, the initial value of one of the multiple bifurcation parameters pᵢ may be determined based on one value (e.g., the sum of the absolute values of the elements) determined by the corresponding problem parameter subset. When the one value determined by the corresponding problem parameter subset is large, the initial value of the corresponding one of the multiple bifurcation parameters pᵢ is set to be large.

As mentioned above, the initial values of the bifurcation parameter {p} are set based on the problem parameter {J}(step S120). Subsequently, the processor 70 uses the initial values that are set to repeatedly perform the first and second variable updates (step S130). The processor 70 may modify the bifurcation parameter set {p} during iterations of the first and second variable updates. For example, the processor 70 may modify the first bifurcation parameter p₁ according to a corresponding one of the multiple first variables xᵢ (e.g., x₁).

For the fourth and eighth formulas above, the relationships of the following fifteenth and sixteenth formulas is applicable to the weight parameter set {m}.

$${m}_{i} = {p}_{i 0} \qquad ( 15 )$$

$${m}_{i} = 1 \qquad ( 16 )$$

The weight parameter set {m} may be eliminated from the fourth and eighth formulas by applying the sixteenth formula.

According to the embodiment, the weight parameter set {m} may be modified according to the first variable set {x}. One of the multiple weight parameters, mᵢ, included in the weight parameter set {m} corresponds to one of the multiple first variables, xᵢ, included in the first variable set {x}. For example, mᵢ is modified to decrease as the absolute value of x; increases. The weight parameter set {m} includes a first weight parameter m₁ and a second weight parameter m₂. The first weight parameter m₁ corresponds to one of the multiple first variables xᵢ. The second weight parameter m₂ corresponds to another one of the multiple first variables xᵢ. The first weight parameter m₁ is different from the second weight parameter m₂.

Thus, different values are applicable as the initial values of the bifurcation parameter set {p}; and different values are applicable as the weight parameter set {m}. Or, different values are applicable as the initial values of the bifurcation parameter set {p}; and the same value is applicable as the weight parameter set {m}. Furthermore, as described below, the same value is applicable as the initial values of the bifurcation parameter set {p}; and different values are applicable as the weight parameter set {m}.

The eighth and ninth formulas above can be modified as in the following seventeenth, eighteenth, and nineteenth formulas.

$${\dot{x}}_{i} = {y}_{i} \qquad ( 17 )$$

$${\dot{y}}_{i} = - {p}_{i}^{′} {x}_{i} + {c}_{i}^{′} f ( {J}_{i} , \{ x \} ) \qquad ( 18 )$$

$${p}_{i 0}^{′} = \frac{{p}_{i 0}}{{m}_{i}} , {c}_{i}^{′} = \frac{c}{{m}_{i}} \qquad ( 19 )$$

The update formulas corresponding to the seventeenth and eighteenth formulas become the following twentieth and twenty-first formulas.

$${x}_{i} ← {x}_{i} + {dty}_{i} \qquad ( 20 )$$

$${y}_{i} ← {y}_{i} + dt ( - {p}_{i}^{′} {x}_{i} + {c}_{i}^{′} f ( {J}_{i} , \{ x \} ) ) \qquad ( 21 )$$

The function f of the twenty-first formula is represented by, for example, the following twenty-second formula.

$$f ( {J}_{i} , \{ x \} ) = {\sum }_{j = 1}^{N} {J}_{i , j} {x}_{j} \qquad ( 22 )$$

The processor 70 may perform the processing based on the twentieth formula and the twenty-first formula. In such a case, at least two initial values included in the multiple bifurcation parameter sets {p′} may be set to be different.

According to the embodiment, at least two values included in the coefficient parameter set {c′} of the second term of the twenty-first formula may be set to be different from one another. According to the embodiment, the multiple bifurcation parameter sets {p′} and the coefficient parameter set {c′} may be modified according to the first variable set {x}.

When the fourteenth and fifteenth formulas above are employed, the nineteenth formula becomes the twenty-third formula.

$${{p}^{′}}_{i 0} = 1 , {c}_{i}^{′} = \frac{c}{{p}_{0} {\sum }_{j = 1}^{N} \vert {J}_{i , j} \vert} \qquad ( 23 )$$

The twenty-fourth to twenty-seventh formulas are applicable when the eleventh, twelfth, and thirteenth formulas are used as the Hamiltonian H.

$${\dot{x}}_{i} = {y}_{i} \qquad ( 24 )$$

$${\dot{y}}_{i} = - {\sum }_{j} {{p}^{′}}_{i , j} {x}_{j} + {\sum }_{j} {c}_{i , j}^{′} f ( {J}_{i} , \{ x \} ) \qquad ( 25 )$$

$${{p}^{′}}_{i , j} ( 0 ) = {\sum }_{k} {b}_{i , k}^{′} {p}_{k , j} ( 0 ) \qquad ( 26 )$$

$${c}_{i , j}^{′} = {cb}_{i , j}^{′} \qquad ( 27 )$$

b′_{i,k} of the twenty-sixth formula is the entries of the inverse matrix B′ of the positive definite symmetric matrix B. p_{k,j(0)} of the twenty-sixth formula is the initial value of p_{k,j}. p′_{k,j(0)} of the twenty-sixth formula is the initial value of p′_{k,j}. The seventeenth, eighteenth, and nineteenth formulas are one example of the twenty-fourth, twenty-fifth, twenty-sixth, and twenty-seventh formulas.

According to the embodiment, for example, parallel processing may be performed. For example, the processor 70 may be configured to update a part of the second variable set {y} and another part of the second variable set {y} in parallel in the second variable update.

For example, as described with reference to FIG. 2, the processor 70 includes the first processing part 70a and the second processing part 70b. The first processing part 70a is configured to update a part of the second variable set {y} in the second variable update. The second processing part 70b is configured to update another part of the second variable set {y} in the second variable update. At least a part of the operation of the first processing part 70a may be performed in parallel (simultaneously) with at least a part of the operation of the second processing part 70b.

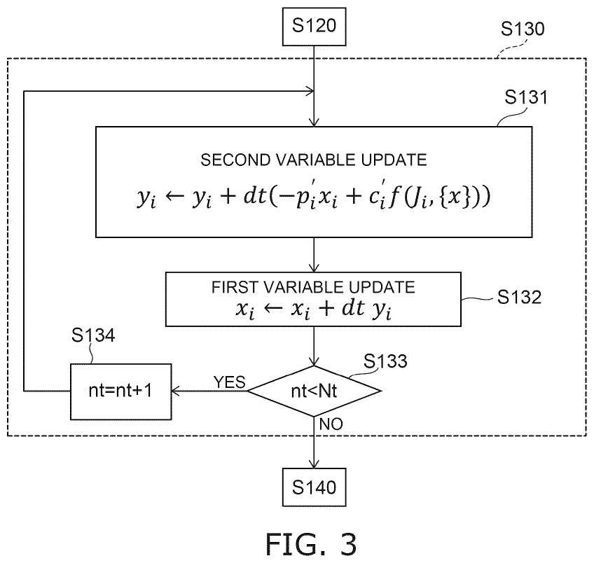

FIG. 3 is a flowchart illustrating an operation of the calculating device according to the embodiment.

In step S130 of one example as shown in FIG. 3, the first variable update (step S132) is performed after the second variable update (step S131). The number of iterations n1 is compared with a determined value Nt (step S133). When the iteration number n1 is less than the determined value Nt, the iteration number n1 is increased (step S134), and then the flow returns to step S131. When the iteration number n1 is not less than the determined value Nt, step S130 ends, and the flow proceeds to step S140.

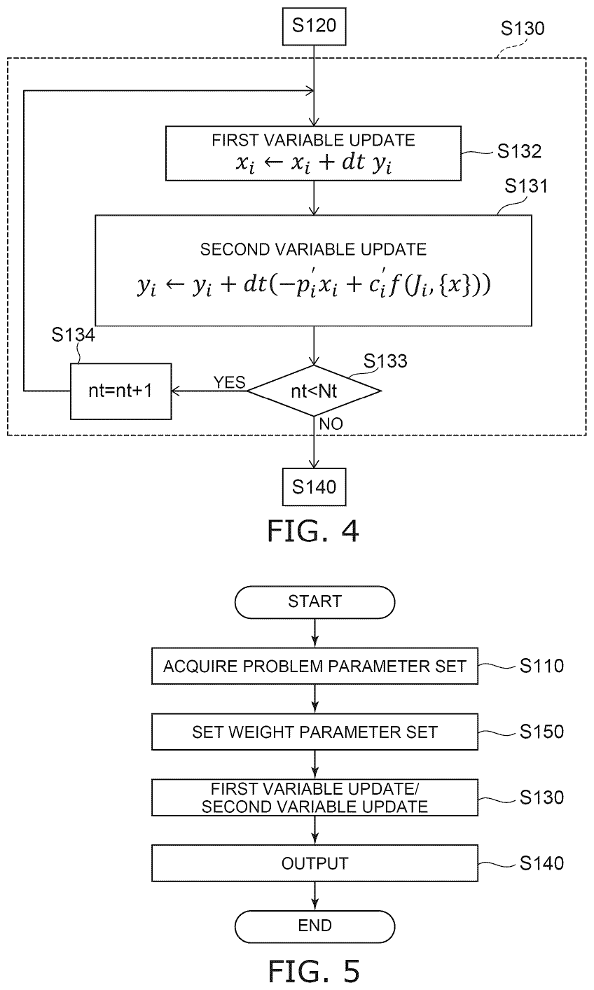

FIG. 4 is a flowchart illustrating an operation of the calculating device according to the embodiment.

As shown in FIG. 4, step S131 may be performed after step S132 in one of the multiple iterations.

### Second Embodiment

According to the second embodiment, the processor 70 uses mutually-different weight parameters.

FIG. 5 is a flowchart illustrating an operation of the calculating device according to the embodiment.

As shown in FIG. 5, the acquisition part 78 acquires the problem parameter set {J}(step S110). For example, the processor 70 sets the weight parameter set {m}(step S150). The processor 70 repeatedly performs the first variable update of updating the first variable set {x} and the second variable update of updating the second variable set {y}(step S130).

The weight parameter set {m} may be determined based on the problem parameter set {J}. For example, the processor 70 is configured to determine the multiple weight parameters mᵢ included in the weight parameter set {m} based on the problem parameter set {J}. The initial values of the weight parameter set {m} may be determined according to the problem parameter set {J}.

For example, the problem parameter set {J} includes the first problem parameter subset J₁ and the second problem parameter subset J₂. For example, the first weight parameter m₁ is determined based on a first sum of the absolute values of the multiple elements included in the first problem parameter subset J₁. For example, the second weight parameter m₂ is determined based on a second sum of the absolute values of the multiple elements included in the second problem parameter subset J₂. For example, when the first sum is greater than the second sum, m₁ is greater than m₂; however, for example, when the first sum is less than the second sum, m₁ is less than m₂.

Thus, the multiple weight parameters mᵢ may be determined based on one value (e.g., the sum of the absolute values of the elements) determined by the corresponding problem parameter subset. When the one value determined by the corresponding problem parameter subset is large, the corresponding multiple weight parameters mᵢ are set to be large.

In the second variable update, the processor 70 updates the second variable set {y} by using a function including a first term and a second term. The first term includes the first variable set {x} and the bifurcation parameter set {p}. The second term includes the first variable set {x} and the problem parameter set {J} acquired by the acquisition part 78. In the first variable update, the processor 70 updates the first variable set {x} by using the second variable set {y} updated in the second variable update.

In the first variable update, the first variable set {x} is updated using the product of the weight parameter set {m} and the updated second variable set {y}. The multiple weight parameters mᵢ included in the weight parameter set {m} include the first weight parameter m₁ and the second weight parameter m₂. The first weight parameter m₁ corresponds to one of the multiple first variables {x}. The second weight parameter m₂ corresponds to another one of the multiple first variables {x}. The first weight parameter mᵢ is different from the second weight parameter m₂. A calculating device can be provided in which the calculation accuracy can be increased.

According to the second embodiment, the processor 70 may update a part of the second variable set {y} and another part of the second variable set {y} in parallel in the second variable update, even when a weight parameter set {m} such as those described above is used. For example, the processor 70 may include the first processing part 70a and the second processing part 70b. The first processing part 70a is configured to update a part of the second variable set {y} in the second variable update. The second processing part 70b is configured to update another part of the second variable set {y} in the second variable update. At least a part of these updates may be performed in parallel (simultaneously).

According to the second embodiment, the first term includes the product of the first variable set {x} and the bifurcation parameter set {p}. The second term includes the product-sum of the first variable set {x} and the problem parameter set {J} acquired by the acquisition part 78.

### Third Embodiment

According to the third embodiment, the acquisition part 78 acquires at least a part of the initial values of the bifurcation parameter set {p}.

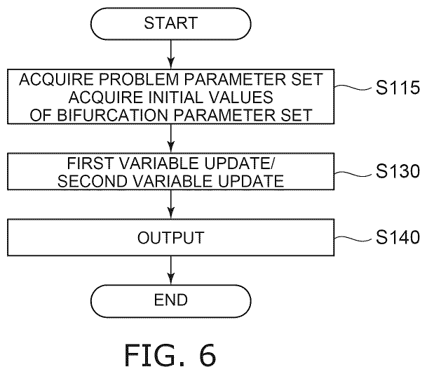

FIG. 6 is a flowchart illustrating an operation of the calculating device according to the embodiment.

As shown in FIG. 6, the acquisition part 78 acquires the problem parameter set {J} and information related to the initial values of at least a part of the bifurcation parameter set {p}(step S115). The processor 70 repeatedly performs the first variable update of updating the first variable set {x} and the second variable update of updating the second variable set {y}(step S130).

According to the third embodiment as well, the processor 70 updates the second variable set {y} by using a function including the first and second terms in the second variable update. The first term includes the first variable set {x} and the bifurcation parameter set {p}. The second term includes the first variable set {x} and the problem parameter set {J} acquired by the acquisition part 78. In the first variable update, the processor 70 updates the first variable set {x} by using the second variable set {y} updated in the second variable update.

The bifurcation parameter set {p} includes the first bifurcation parameter p₁ and the second bifurcation parameter p₂. The first bifurcation parameter p₁ corresponds to one of the multiple first variables xᵢ included in the first variable set {x}. The second bifurcation parameter p₂ corresponds to another one of the multiple first variables {x}. The first initial value p₁₍₀₎ of the first bifurcation parameter p₁ is different from the second initial value p₂₍₀₎ of the second bifurcation parameter p₂. The information related to the first initial value p₁₍₀₎ and the second initial value p₂₍₀₎ is acquired by the acquisition part 78.

The initial values of the multiple bifurcation parameters pᵢ included in the bifurcation parameter set {p} may correspond to the problem parameter set {J}. For example, the multiple problem parameters J_{i,j} included in the problem parameter set {J} include the multiple first problem parameter subsets J₂ and the multiple second problem parameter subsets J₂. The first initial value p₁₍₀₎ may be based on the first sum of the absolute values of the multiple first problem parameter subsets J₁. The second initial value p₂₍₀₎ may be based on the second sum of the absolute values of the multiple second problem parameter subsets J₂. When the first absolute value is greater than the second absolute value, the first initial value p₁₍₀₎ is greater than the second initial value p₂₍₀₎.

According to the third embodiment as well, the first term includes, for example, the product of the first variable set {x} and the bifurcation parameter set {p}. The second term includes the product-sum of the first variable set {x} and the problem parameter set {J} acquired by the acquisition part 78.

According to the third embodiment as well, the processor 70 may be configured to update a part of the second variable set {y} and another part of the second variable set {y} in parallel in the second variable update. The processor 70 may include the first processing part 70a and the second processing part 70b. The first processing part 70a is configured to update a part of the second variable set {y} in the second variable update. The second processing part 70b is configured to update another part of the second variable set {y} in the second variable update.

### Fourth Embodiment

A fourth embodiment relates to a calculation program. The calculation program causes the processor to repeatedly perform the first variable update of updating the first variable set {x} and the second variable update of updating the second variable set {y}. The calculation program causes the processor 70 to perform the processing described with reference to the first to third embodiments. A calculation program is provided in which the calculation accuracy can be increased.

### Fifth Embodiment

A fifth embodiment relates to a calculation method. The calculation method causes the processor 70 to repeatedly perform the first variable update of updating the first variable set {x} and the second variable update of updating the second variable set {y}. The calculation method causes the processor 70 to perform the processing described with reference to the first to third embodiments. A calculation program is provided in which the calculation accuracy can be increased.

An example of a calculation result will now be described. The following calculation example relates to G14, an instance of G-set. The example is known as a benchmark problem of the maximum-cut problem. The maximum-cut problem in which “w_{i,j}” is the weight of the sides is equivalent to an Ising problem in which the J-matrix “J_{i,j}” is defined as “−w_{i,j}” (see, e.g., H. Goto et al., Science Advances 7, eabe7953 (2021)).

The Ising problem is a combinatorial optimization problem that minimizes the Ising energy of the following twenty-eighth formula.

$$E = - \frac{1}{2} {\sum }_{i = 1}^{N} {\sum }_{j = 1}^{N} {J}_{i , j} {s}_{i} {s}_{j} \qquad ( 28 )$$

In the twenty-eighth formula, “sⱼ” is a spin variable taking ±1. “N” is the number of spins. “N” equals the number of edges of the original maximum-cut problem. In a reference example (H. Goto et al., Science Advances 7, eabe7953 (2021)), all “p;” take the same value in the update formula of the first to third formulas. In the reference example, all “pᵢ” are linearly reduced monotonously from 1 to 0. All “mᵢ” are 1. In the reference example, sign(xᵢ) is used instead of “xⱼ” in the function f of the second formula. In the reference example, “c” is defined as the twenty-ninth formula (see H. Goto et al., Science Advances 7, eabe7953 (2021)).

$$c = \frac{1}{2} \sqrt{\frac{N - 1}{{\sum }_{i = 1}^{N} {\sum }_{j = 1}^{N} {J}_{i , j}^{2}}} \qquad ( 29 )$$

In the reference example, dt was 0.5 with the number of steps (the iteration number of the first and second variable updates) of 10,000. The probability of obtaining the optimal solution (best known value) in the reference example was 0.004%.

In the calculation example according to the embodiment, the initial values of p; were set to different values dependent on the J-matrix as in the fourteenth formula, and were linearly reduced monotonously toward 0. In the calculation example according to the embodiment, the coefficient p₀ was set to 0.3c. The other settings of the calculation example according to the embodiment were the same as those of the method of the reference example above. In the calculation example according to the embodiment, the probability of obtaining the optimal solution was 0.44%. In the calculation example according to the embodiment, the probability of obtaining the optimal solution was about 100 times higher than the probability of obtaining the optimal solution in the reference example.

Embodiments may include the following configurations (e.g., technological proposals).

### Technological Proposal 1

A calculating device, comprising:
an acquisition part configured to acquire a problem parameter set; and
a processor,
the processor being configured to repeatedly perform
   a first variable update of updating a first variable set, and
   a second variable update of updating a second variable set,
in the second variable update, the processor updating the second variable set by using a function including a first term and a second term,
the first term including the first variable set and a bifurcation parameter set,
the second term including the first variable set and the problem parameter set acquired by the acquisition part,
in the first variable update, the processor updating the first variable set by using the second variable set updated in the second variable update,
the bifurcation parameter set including a first bifurcation parameter and a second bifurcation parameter,
the first bifurcation parameter corresponding to one of a plurality of first variables included in the first variable set,
the second bifurcation parameter corresponding to another one of the plurality of first variables, and
a first initial value of the first bifurcation parameter being different from a second initial value of the second bifurcation parameter.

### Technological Proposal 2

The calculating device according to Technological Proposal 1, wherein
the processor is configured to determine initial values of a plurality of bifurcation parameters included in the bifurcation parameter set based on the problem parameter set.

### Technological Proposal 3

The calculating device according to Technological Proposal 2, wherein
the problem parameter set includes a first problem parameter subset and a second problem parameter subset,
the first initial value is determined based on a first sum of absolute values of a plurality of elements included in the first problem parameter subset,
the second initial value is determined based on a second sum of absolute values of a plurality of elements included in the second problem parameter subset, and
the first sum is greater than the second sum, and the first initial value is greater than the second initial value.

### Technological Proposal 4

The calculating device according to any one of Technological Proposals 1 to 3, wherein
the processor is configured to modify the first bifurcation parameter according to the one of the plurality of first variables during iterations of the first and second variable updates.

### Technological Proposal 5

The calculating device according to any one of Technological Proposals 1 to 4, wherein
in the first variable update, the first variable set is updated using a product of a weight parameter set and the updated second variable set,
a plurality of weight parameters included in the weight parameter set includes a first weight parameter and a second weight parameter,
the first weight parameter corresponds to one of the plurality of first variables,
the second weight parameter corresponds to another one of the plurality of first variables, and
the first weight parameter is different from the second weight parameter.

### Technological Proposal 6

The calculating device according to any one of Technological Proposals 1 to 5, wherein
the calculating device is configured to update a part of the second variable set and update another part of the second variable set in parallel in the second variable update.

### Technological Proposal 7

The calculating device according to any one of Technological Proposals 1 to 5, wherein
the processor includes a first processing part and a second processing part,
the first processing part is configured to update a part of the second variable set in the second variable update, and
the second processing part is configured to update another part of the second variable set in the second variable update.

### Technological Proposal 8

The calculating device according to any one of Technological Proposals 1 to 7, wherein
the first term includes a product of the first variable set and the bifurcation parameter set, and
the second term includes a product-sum of the first variable set and the problem parameter set acquired by the acquisition part.

### Technological Proposal 9

A calculating device, comprising:
an acquisition part configured to acquire a problem parameter set; and
a processor,
the processor being configured to repeatedly perform
   a first variable update of updating a first variable set, and
   a second variable update of updating a second variable set,
in the second variable update, the processor updating the second variable set by using a function including a first term and a second term,
the first term including the first variable set and a bifurcation parameter set,
the second term including the first variable set and the problem parameter set acquired by the acquisition part,
in the first variable update, the processor updating the first variable set by using the second variable set updated in the second variable update,
in the first variable update, the first variable set being updated using a product of a weight parameter set and the updated second variable set,
a plurality of weight parameters included in the weight parameter set including a first weight parameter and a second weight parameter,
the first weight parameter corresponding to one of the plurality of first variables,
the second weight parameter corresponding to another one of the plurality of first variables,
the first weight parameter being different from the second weight parameter.

### Technological Proposal 10

The calculating device according to Technological Proposal 9, wherein
the processor is configured to update a part of the second variable set and update another part of the second variable set in parallel in the second variable update.

### Technological Proposal 11

The calculating device according to Technological Proposal 9, wherein
the processor includes a first processing part and a second processing part,
the first processing part is configured to update a part of the second variable set in the second variable update, and
the second processing part is configured to update another part of the second variable set in the second variable update.

### Technological Proposal 12

The calculating device according to any one of Technological Proposals 9 to 11, wherein
the first term includes a product of the first variable set and the bifurcation parameter set, and
the second term includes a product-sum of the first variable set and the problem parameter set acquired by the acquisition part.

### Technological Proposal 13

A calculating device, comprising:
an acquisition part configured to acquire
   information related to an initial value of at least a part of a bifurcation parameter set, and
   a problem parameter set; and
a processor,
the processor being configured to repeatedly perform
   a first variable update of updating a first variable set, and
   a second variable update of updating a second variable set,
in the second variable update, the processor updating the second variable set by using a function including a first term and a second term,
the first term including the first variable set and the bifurcation parameter set,
the second term including the first variable set and the problem parameter set acquired by the acquisition part,
in the first variable update, the processor updating the first variable set by using the second variable set updated in the second variable update,
the bifurcation parameter set including a first bifurcation parameter and a second bifurcation parameter,
the first bifurcation parameter corresponding to one of a plurality of first variables included in the first variable set,
the second bifurcation parameter corresponding to another one of the plurality of first variables, and
a first initial value of the first bifurcation parameter being different from a second initial value of the second bifurcation parameter.

### Technological Proposal 14

The calculating device according to Technological Proposal 13, wherein
the processor is configured to update a part of the second variable set and update another part of the second variable set in parallel in the second variable update.

### Technological Proposal 15

The calculating device according to Technological Proposal 13, wherein
the processor includes a first processing part and a second processing part,
the first processing part is configured to update a part of the second variable set in the second variable update, and
the second processing part is configured to update another part of the second variable set in the second variable update.

### Technological Proposal 16

The calculating device according to any one of Technological Proposals 13 to 15, wherein
the first term includes a product of the first variable set and the bifurcation parameter set, and
the second term includes a product-sum of the first variable set and the problem parameter set acquired by the acquisition part.

### Technological Proposal 17

The calculating device according to Technological Proposal 1, wherein
the plurality of first variables includes xᵢ,
i is an integer not less than 1 and not more than N,
N is an integer not less than 2,
a plurality of second variables included in the second variable set includes yᵢ,
a plurality of bifurcation parameters included in the bifurcation parameter set includes pᵢ,
a plurality of problem parameters included in the problem parameter set includes J_{i,j}, and
j is an integer not less than 1 and not more than M, and
M is an integer not less than 2.

### Technological Proposal 18

A calculation program,
the calculation program being configured to cause a processor to repeatedly perform
   a first variable update of updating a first variable set, and
   a second variable update of updating a second variable set,
in the second variable update, the processor updating the second variable set by using a function including a first term and a second term,
the first term including the first variable set and a bifurcation parameter set,
the second term including a problem parameter set and the first variable set,
in the first variable update, the processor updating the first variable set by using the second variable set updated in the second variable update,
the bifurcation parameter set including a first bifurcation parameter and a second bifurcation parameter,
the first bifurcation parameter corresponding to one of a plurality of first variables included in the first variable set,
the second bifurcation parameter corresponding to another one of the plurality of first variables, and
a first initial value of the first bifurcation parameter being different from a second initial value of the second bifurcation parameter.

### Technological Proposal 19

A calculation method, comprising:
causing a processor to repeatedly perform
   a first variable update of updating a first variable set, and
   a second variable update of updating a second variable set,
in the second variable update, the processor updating the second variable set by using a function including a first term and a second term,
the first term including the first variable set and a bifurcation parameter set,
the second term including a problem parameter set and the first variable set,
in the first variable update, the processor updating the first variable set by using the second variable set updated by the second variable update,
the bifurcation parameter set including a first bifurcation parameter and a second bifurcation parameter,
the first bifurcation parameter corresponding to one of a plurality of first variables included in the first variable set,
the second bifurcation parameter corresponding to another one of the plurality of first variables, and
a first initial value of the first bifurcation parameter being different from a second initial value of the second bifurcation parameter.

According to embodiments, a calculating device, a calculation program, and a calculation method can be provided in which the calculation accuracy can be increased.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the calculating device such as processors, acquisition parts, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all calculating devices, all calculation programs, and all calculation methods practicable by an appropriate design modification by one skilled in the art based on the calculating devices, the calculation programs, and the calculation methods described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A calculating device, comprising:
an acquisition part configured to acquire a problem parameter set; and
a processor,
the processor being configured to repeatedly perform
a first variable update of updating a first variable set, and
a second variable update of updating a second variable set,
in the second variable update, the processor updating the second variable set by using a function including a first term and a second term,
the first term including the first variable set and a bifurcation parameter set,
the second term including the first variable set and the problem parameter set acquired by the acquisition part,
in the first variable update, the processor updating the first variable set by using the second variable set updated in the second variable update,
the bifurcation parameter set including a first bifurcation parameter and a second bifurcation parameter,
the first bifurcation parameter corresponding to one of a plurality of first variables included in the first variable set,
the second bifurcation parameter corresponding to another one of the plurality of first variables, and
a first initial value of the first bifurcation parameter being different from a second initial value of the second bifurcation parameter.

2. The device according to claim 1, wherein
the processor is configured to determine initial values of a plurality of bifurcation parameters included in the bifurcation parameter set based on the problem parameter set.

3. The device according to claim 2, wherein
the problem parameter set includes a first problem parameter subset and a second problem parameter subset,
the first initial value is determined based on a first sum of absolute values of a plurality of elements included in the first problem parameter subset,
the second initial value is determined based on a second sum of absolute values of a plurality of elements included in the second problem parameter subset, and
the first sum is greater than the second sum, and
the first initial value is greater than the second initial value.

4. The device according to claim 1, wherein
the processor is configured to modify the first bifurcation parameter according to the one of the plurality of first variables during iterations of the first and second variable updates.

5. The device according to claim 1, wherein
in the first variable update, the first variable set is updated using a product of a weight parameter set and the updated second variable set,
a plurality of weight parameters included in the weight parameter set includes a first weight parameter and a second weight parameter,
the first weight parameter corresponds to one of the plurality of first variables,
the second weight parameter corresponds to another one of the plurality of first variables, and
the first weight parameter is different from the second weight parameter.

6. The device according to claim 1, wherein
the calculating device is configured to update a part of the second variable set and update another part of the second variable set in parallel in the second variable update.

7. The device according to claim 1, wherein
the processor includes a first processing part and a second processing part,
the first processing part is configured to update a part of the second variable set in the second variable update, and
the second processing part is configured to update another part of the second variable set in the second variable update.

8. The device according to claim 1, wherein
the first term includes a product of the first variable set and the bifurcation parameter set, and
the second term includes a product-sum of the first variable set and the problem parameter set acquired by the acquisition part.

9. A calculating device, comprising:
an acquisition part configured to acquire a problem parameter set; and
a processor,
the processor being configured to repeatedly perform
a first variable update of updating a first variable set, and
a second variable update of updating a second variable set,
in the second variable update, the processor updating the second variable set by using a function including a first term and a second term,
the first term including the first variable set and a bifurcation parameter set,
the second term including the first variable set and the problem parameter set acquired by the acquisition part,
in the first variable update, the processor updating the first variable set by using the second variable set updated in the second variable update,
in the first variable update, the first variable set being updated using a product of a weight parameter set and the updated second variable set,
a plurality of weight parameters included in the weight parameter set including a first weight parameter and a second weight parameter,
the first weight parameter corresponding to one of the plurality of first variables,
the second weight parameter corresponding to another one of the plurality of first variables,
the first weight parameter being different from the second weight parameter.

10. The device according to claim 9, wherein
the processor is configured to update a part of the second variable set and update another part of the second variable set in parallel in the second variable update.

11. The device according to claim 9, wherein
the processor includes a first processing part and a second processing part,
the first processing part is configured to update a part of the second variable set in the second variable update, and
the second processing part is configured to update another part of the second variable set in the second variable update.

12. The device according to claim 9, wherein
the first term includes a product of the first variable set and the bifurcation parameter set, and
the second term includes a product-sum of the first variable set and the problem parameter set acquired by the acquisition part.

13. A calculating device, comprising:
an acquisition part configured to acquire
information related to an initial value of at least a part of a bifurcation parameter set, and
a problem parameter set; and
a processor,
the processor being configured to repeatedly perform
a first variable update of updating a first variable set, and
a second variable update of updating a second variable set,
in the second variable update, the processor updating the second variable set by using a function including a first term and a second term,
the first term including the first variable set and the bifurcation parameter set,
the second term including the first variable set and the problem parameter set acquired by the acquisition part,
in the first variable update, the processor updating the first variable set by using the second variable set updated in the second variable update,
the bifurcation parameter set including a first bifurcation parameter and a second bifurcation parameter,
the first bifurcation parameter corresponding to one of a plurality of first variables included in the first variable set,
the second bifurcation parameter corresponding to another one of the plurality of first variables, and
a first initial value of the first bifurcation parameter being different from a second initial value of the second bifurcation parameter.

14. The device according to claim 13, wherein
the processor is configured to update a part of the second variable set and update another part of the second variable set in parallel in the second variable update.

15. The device according to claim 13, wherein
the processor includes a first processing part and a second processing part,
the first processing part is configured to update a part of the second variable set in the second variable update, and
the second processing part is configured to update another part of the second variable set in the second variable update.

16. The device according to claim 13, wherein
the first term includes a product of the first variable set and the bifurcation parameter set, and
the second term includes a product-sum of the first variable set and the problem parameter set acquired by the acquisition part.

17. The device according to claim 1, wherein
the plurality of first variables includes xᵢ,
i is an integer not less than 1 and not more than N,
N is an integer not less than 2,
a plurality of second variables included in the second variable set includes yᵢ,
a plurality of bifurcation parameters included in the bifurcation parameter set includes pᵢ,
a plurality of problem parameters included in the problem parameter set includes J_{i,j}, and
j is an integer not less than 1 and not more than M, and
M is an integer not less than 2.

18. A calculation program,
the calculation program being configured to cause a processor to repeatedly perform
a first variable update of updating a first variable set, and
a second variable update of updating a second variable set,
in the second variable update, the processor updating the second variable set by using a function including a first term and a second term,
the first term including the first variable set and a bifurcation parameter set,
the second term including a problem parameter set and the first variable set,
in the first variable update, the processor updating the first variable set by using the second variable set updated in the second variable update,
the bifurcation parameter set including a first bifurcation parameter and a second bifurcation parameter,
the first bifurcation parameter corresponding to one of a plurality of first variables included in the first variable set,
the second bifurcation parameter corresponding to another one of the plurality of first variables, and
a first initial value of the first bifurcation parameter being different from a second initial value of the second bifurcation parameter.

19. A calculation method, comprising:
causing a processor to repeatedly perform
a first variable update of updating a first variable set, and
a second variable update of updating a second variable set,
in the second variable update, the processor updating the second variable set by using a function including a first term and a second term,
the first term including the first variable set and a bifurcation parameter set,
the second term including a problem parameter set and the first variable set,
in the first variable update, the processor updating the first variable set by using the second variable set updated by the second variable update,
the bifurcation parameter set including a first bifurcation parameter and a second bifurcation parameter,
the first bifurcation parameter corresponding to one of a plurality of first variables included in the first variable set,
the second bifurcation parameter corresponding to another one of the plurality of first variables, and
a first initial value of the first bifurcation parameter being different from a second initial value of the second bifurcation parameter.
